(19) United States
(12) Patent Application Publication
(10) Pub. No.: US 2010/0280876 A1
(43) Pub. Date: Nov. 4, 2010

(54) IMPLICIT RATING OF ADVERTISEMENTS

(75) Inventor: Todd Bowra, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/433,422

(22) Filed: Apr. 30, 2009

(51) Int. Cl. G06Q 30/00; G06Q 10/00; G06Q 40/00; G06F 17/30

(52) U.S. Cl. 705/10; 705/32; 705/14.49

(57) ABSTRACT

Methods for measuring resonance of an ad with a user. Ads are delivered to a user during a commercial break of a program being delivered by a content provider. Each ad is associated with a unique identifier and at least one tag describing an attribute of the ad. Input from the user is received during presentation of an ad indicating that the user would like to stop viewing the ad before the ad has ended. The user's interest in the ad is determined based on the amount of time that the user viewed the ad before, and the instance of the user's viewing behavior is stored in a user profile database.

### BACKGROUND

Online media content providers use advertisements to generate revenue in return for presenting programs via their service. Like all providers, it is desirable to ensure advertisers that their viewers review the ads presented and that ads are targeted to the correct viewers. Different types of feedback mechanisms have been developed, but all are limited in some way. Generally, users are presented with advertisements which must be viewed in order to view a program on the service.

Some content providers require a user to sign-in in order to view content available on the website and obtain a limited amount of information about the user. The sign-in process often requires the user to enter a limited amount of information such as username, first and last name, gender, email address, date of birth, and the like. The sign-in process also may display categories of subject matter that the user can select to indicate an interest in. The information entered by the user is often not verified by the content provider to determine its accuracy. As a result, content providers cannot rely on the accuracy of the information and can only offer a limited level of granularity when selling ads against their content.

### SUMMARY

One aspect of the present technology is a method for measuring resonance of an ad with a user. Ads are delivered to a user during a commercial break of a program being delivered by a content provider to the user. Each ad is associated with a unique identifier and at least one tag describing an attribute of the ad. During presentation of an ad, the technology allows a user to skip all or a portion of the ad. The user's interest in the ad is determined based on the amount of time that the user viewed the ad. A record of this instance of user viewing behavior is created and stored in a user profile database, creating a searchable database of user viewing behavior. Relationships of user viewing behavior may be developed to help advertisers better target their ads, and provide the content provider the ability to generate revenue by charging for this information.

In one embodiment, users are provided the opportunity to select which ad to view first during the commercial break. Upon identifying an upcoming commercial break in a program being delivered by a content provider to a user, an ad server selects at least two ads from an advertising database. Each ad is associated with a unique identifier and at least one tag describing an attribute of the ad. The selected ads are delivered to the user and displayed for selection by the user. Upon receiving input from the user indicating that the user selected one of the ads, a record of user viewing behavior is created and stored in a user profile database. The selected ad is delivered to the user upon the start of the commercial break.

One aspect of the present technology is to provide a system for measuring resonance of an ad with a user. The system comprises a content server, an ad server, a user profile database and a user behavior engine. The content server is configured to deliver at least one ad to a user during a commercial break of a program. Each ad is associated with a unique identifier and at least one tag describing an attribute of the ad. The ad server is configured to receive input from the user indicating that the user would like to stop viewing the ad before the ad has ended, determine the user's interest in each ad based on the amount of time that the user viewed the ad, and add a record of user viewing behavior associated with each ad to the user profile database. The user profile database is configured to store each record of user viewing behavior. The system also includes a user behavior engine that develops relationships between data stored in each record of user viewing behavior. The relationships may be provided to an advertiser to help the advertiser better target their ads, and allow the content provider to generate additional revenue for providing the information to the advertisers.

One aspect of the present technology is to encourage users to view the entire duration of each ad presented during a commercial break. The technology may effectively penalize a user for choosing to skip at least one ad presented during a commercial break by extending the originally scheduled duration of the commercial break. If the commercial break was originally scheduled for sixty seconds, and the user skips the second thirty-second ad after watching it for fifteen seconds (already watched entire first ad), the technology will provide a third thirty-second ad with only fifteen seconds remaining in the break. If the user watches the entire third ad, the user ends up watching seventy-five seconds of ads instead of the originally scheduled sixty seconds of ads. In some embodiments, the technology will return the user to the program even though there is time remaining in the commercial break.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an exemplary content distribution network.

FIG. 2 depicts a processing system suitable for use in the network described with respect to FIG. 1.

FIG. 3 depicts a flow chart illustrating exemplary steps for storing an ad received from an advertiser.

FIG. 4 depicts a flow chart of an embodiment of delivering ads to users.

FIG. 5 depicts a flow chart illustrating exemplary steps of storing instances of user viewing behavior.

FIG. 6 depicts a flow chart of an embodiment for determining whether a user is interested in an ad.

FIG. 7 depicts a flow chart of another embodiment of determining a user's interest in an ad.

FIGS. 8A-8B depict exemplary user interest tables.

FIG. 9 depicts a flow chart of an embodiment of monetizing partial delivery of an ad.

FIG. 10 depicts an exemplary view time table for monetizing delivery of an ad.

FIG. 11 depicts another embodiment of a view time table for monetizing delivery of an ad.

FIG. 12 depicts a flow chart of another embodiment of delivering ads to a user.

FIG. 13 depicts a flow chart of an embodiment of providing advertisers feedback regarding an advertisement.

### DETAILED DESCRIPTION

The technology described herein improves ad targeting by monitoring whether a user skips watching any portion of an ad. Users are provided with the opportunity to skip all or a portion of advertisements presented in breaks of content provided by an online media content provider. Each time a user views an ad, a record of the user's viewing behavior is stored in a user profile database. Each record contains information such as an ad ID, subject matter tags, the amount of time the user viewed the ad, and a user identifier. Creating and storing the records increases a content provider's ability to monetize the ad slots available during a program and helps enable advertisers to better target their ads, without asking the users for any information about themselves.

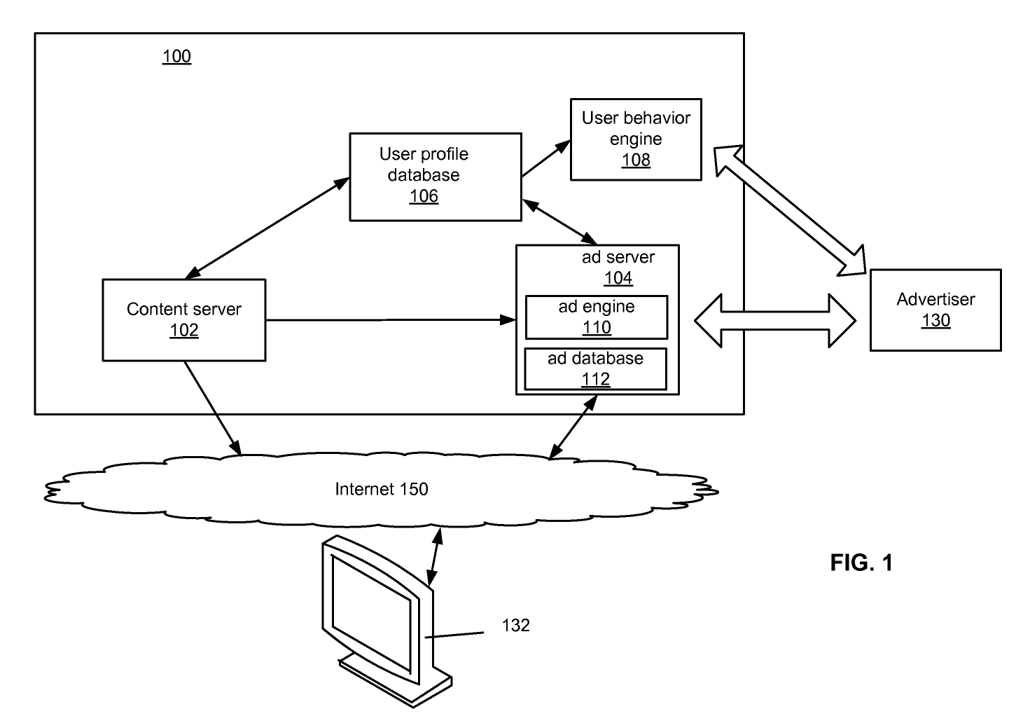

FIG. 1 illustrates an exemplary content distribution network 100 for performing the methods described herein. The network 100 includes a content server 102, an ad server 104, a user profile database 106, and a user behavior engine 108. The content distribution network 100 is only one example of a suitable network and is not intended to suggest any limitation as to the scope of use or functionality of the technology. Neither should the network 100 be interpreted as having any dependency or requirement relating to any one or combination of components illustrated in the exemplary network 100.

The content server 102 allows a content provider to distribute digital content to users. A content provider is referred to herein as a broadcaster (e.g., ABC, NBC, etc.) or a content aggregator (e.g., HULU.com). A broadcaster typically owns a website (e.g., ABC.com) whereby users may stream digital video content of an episode of their favorite television program produced by the broadcaster. A content aggregator aggregates digital content (e.g., television episodes) produced by various broadcasters onto a single website and makes the content available to users via the website. To monetize the website, a broadcaster and aggregator often provide at least one commercial break during the broadcast of the content, during which time at least one ad is provided. As will be discussed in more detail later, the ads delivered during the commercial break are often provided by third-parties that have paid the content provider to display their ad to the user. Ads may vary in duration and promote any product and/or service.

The user viewing device 132 in FIG. 1 is shown as a display for a desktop computer or television. The user viewing device 132 is exemplary only, and may include any device that can view or receive digital content (via a wired or wireless connection) such as, but not limited to, a laptop computer, a smart phone, a mobile phone, a personal digital assistant (PDA), a netbook, consumer electronics devices such as televisions and TV set-top boxes, and any other device known in the art that can receive and display digital content.

Content server 102 is in communication, via Internet 150, with one or more viewing devices 132. The single viewing device 132 shown in FIG. 1 is exemplary only, and is not intended to limit the scope of the technology described herein.

FIG. 1 illustrates that the ad server 104 receives advertising content from an advertiser 130. The ad server 104 includes an ad engine 110 and an ad database 112. Ad server 104 is in communication, via Internet 150, with one or more viewing devices 132. As will be discussed in more detail later, the ad server delivers ads to the viewing device 132 and delivers records of user viewing behavior to the user profile database 106 for storage purposes. Running within or in conjunction with ad server 140 is the ad serving engine 110, which is used to select ads to serve to a user. In one embodiment, ad serving engine 110 is implemented using JavaScript.

The ad serving engine 110 performs several functions. Upon receiving an ad content file (e.g., .wmv file, .mp3 file, etc.) from an advertiser 130, the ad engine assigns a unique identification (ID) to the ad. The ad engine 110 also identifies any metadata associated with the ad received from the advertiser 130. Using the metadata, the ad engine 110 selects relevant subject matter tags and adds the tags to the ad content file. The ad, with the unique ID and tags, is stored in the ad database 112. In addition, upon receiving a call from the content server 102, the ad engine 110 selects ads to serve to a user (e.g., viewing device 132) from the ad database 112. The content server may issue calls for ads in one or more commercial break windows associated with a particular piece of content. As will be generally understood, viewing of content from an online content provider may occur in an interface in a web browser or using a media playing application on a user device. The interface and the media playing application include well known controls allowing users to play, pause, rewind, fast forward and skip segments of content. The function of such controls may be enabled, disabled or limited by the content provider.

In accordance with the present technology, controls such as fast forward and/or skip are enabled during the presentation of advertisements in the ad window. Input by the user to “skip” and advertisement is recorded and interpreted by the ad server and stored in the user profile database. In addition, additional advertisements may be provided to fill the time allotted to the commercial break window, as described herein.

The user profile database 106 includes records of user viewing behavior associating ad interest with each user. For each user, and for each ad viewed by the user, a record storing whether the user is interested in the ad, not interested in the ad, and data such as viewing time, ad subject tags and information associated with the user (e.g., user identifier) is stored. The user behavior engine 108 aggregates and analyzes the records of user viewing behavior stored in the user profile database 106. Additional details of the user behavior engine 108 will be provided later herein.

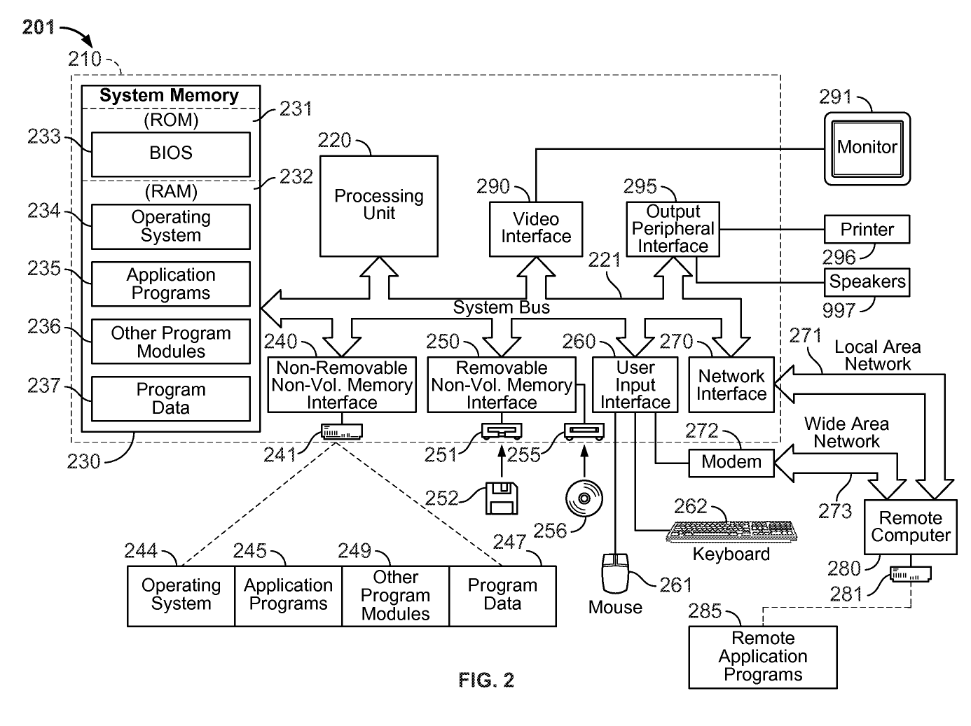

The content server 102, ad server 104, user profile database 106, and user behavior engine 108 may be implemented using one or more processing devices such as that described with respect to FIG. 2. With reference to FIG. 2, an exemplary system for implementing the technology includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. By way of example, and not limitation, communication media includes wired media such as a wired network or direct-wired connection, and wireless media such as RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

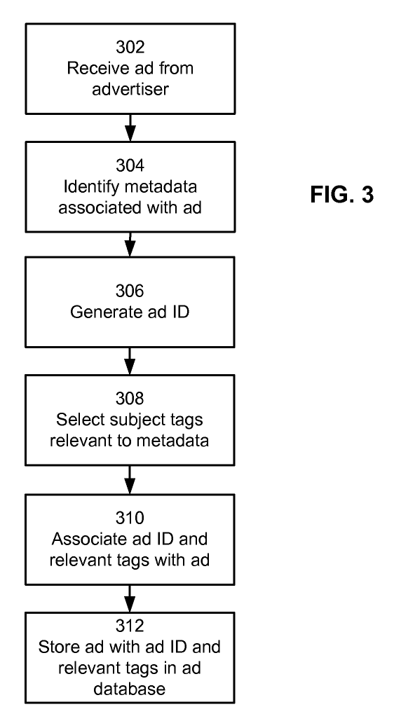

In order to offer a deep level of granularity of the types of ads of interest to users, ads received from advertisers 130 are associated with tags that can be collected, stored and analyzed. FIG. 3 illustrates exemplary steps for associating each new ad received from an advertiser 130 with such tags. At step 302, the ad server 104 receives an ad from an advertiser 130.

At step 304, the ad server 104 identifies any metadata associated with the ad that was provided by the advertiser. In particular, the ad server 104 identifies metadata that describes attributes of the content of the ad. Labeling a media file with metadata is not a standardized process. The metadata associated with an ad prior to sending to the ad to the system 100 is at the discretion of the advertiser. For example, two automobile companies may label their automobile ad with different metadata. A first automobile company may associate their automobile ad with metadata such as the company's name, the model of the car, and a brief description of what is taking place in the ad (e.g., “automobile driving through downtown Seattle”). A second automobile company may associate their automobile ad with metadata such as the launch date of the automobile, the actor/actress in the ad, and the model of the automobile. As will be discussed in more detail later, standardized and non-standardized forms of metadata may be associated with each ad. It is within the scope of the technology described herein to use only the metadata the advertiser 130 associated with the ad for aggregation and analysis of a user's viewing behavior.

At step 306, the ad server 104 generates a unique identifier for the ad. The ad ID further assists the user behavior engine 108 aggregate and analyze the user's viewing behavior. In some embodiments, the unique identifier may comprise a globally unique identifier (GUID). A GUID is a type of identifier used in software applications in order to provide a reference which is unique. The use of a GUID as ad IDs are exemplary only, and are not intended to limit the scope of the technology described herein. Other types of unique identifiers may be associated with each ad. In some embodiments, the advertiser 130 may create the ad ID and associate the ad ID with the ad prior to delivering the ad to the ad server 104. In other embodiments, the content server 102 may generate the ad IDs and associate the ad ID with the ad.

As mentioned above, in one embodiment, metadata in not standardized. However, in an effort to standardize the metadata (e.g., key words) available for tagging the ad, the system 100, in one embodiment, provides a “library” of standardized tags that may be associated with each ad. The library of standardized tags may include any number of keywords, and keywords may be added or deleted from the library. As will be described in more detail later, the data stored in the user profile database 106 may be aggregated by any combination of the metadata provided by the advertiser 130 and the tags provided by the system 100.

At step 308, the ad server 104 selects tags that will be associated with the ad. The term tag used herein is used to refer to metadata comprising a keyword (or keywords) that helps describe an attribute of the ad, a product or service promoted in the ad, etc., and allows it to be found again by the user behavior engine 108. More than one tag may be associated with an ad. Using the automobile ad example, tags selected by the ad server 104 may include keywords such as, but not limited to, “automobile,” “premium,” “sports car,” and “company name.” Any number of tags may be selected, and the tags will vary based on the product or service being advertised. Using the standardized tags provided by the system 100 is not required.

At step 310, the unique ad ID and tags selected in step 308 are associated with the ad. The ad is stored (with the ad ID and tags) in the ad database 112, at step 312. The ad database 112 comprises the pool of ads available for delivery to a user.

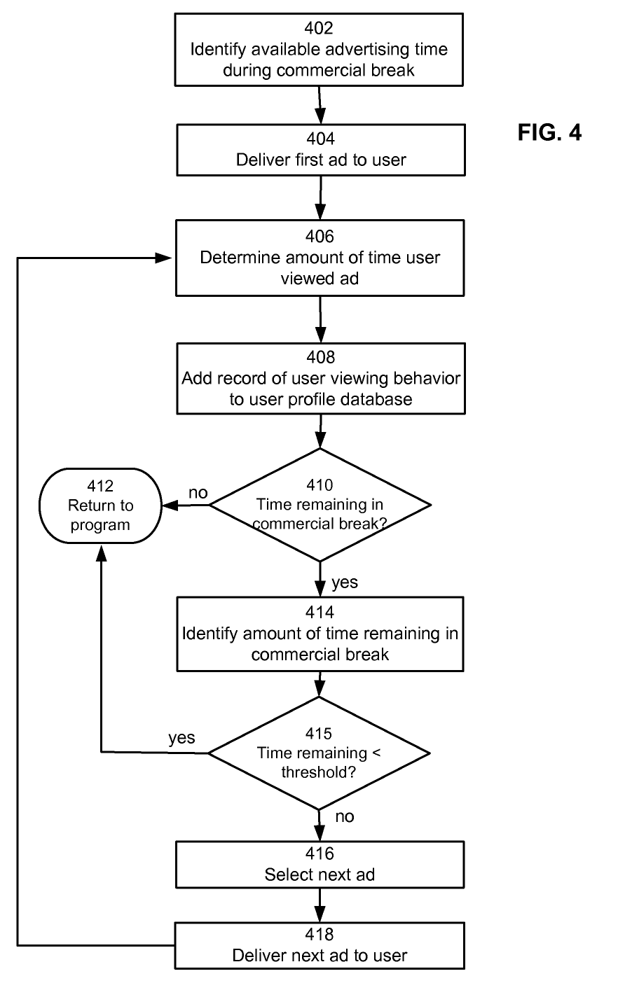

FIG. 4 illustrates exemplary steps for providing ads to a user during a commercial break. In the process of providing ads, records of user viewing behavior are created and stored in the user profile database 106 based on whether the user views the entire ad or chooses to skip a portion of the ad. At step 402, the content server 102 determines the amount of advertising time available during an upcoming commercial break. For the purpose of describing the technology only, the content server 102 determines that there is a one-minute commercial break coming up, at step 402. At the beginning of the commercial break, the ad server 104 delivers a first ad to the user, at step 404. The first ad may be any length of time. The ad may be displayed to the user in the same user interface (UI) that the user is currently watching the content (e.g., television episode). Alternatively, a separate UI may appear (e.g., Windows Media Player) and the ad may be presented in the separate UI. Regardless, the UI provides the user the opportunity to skip any remaining portion of the ad being presented to the user. By way of example only, the UI provides conventional media control buttons to the user, including a fast-forward or skip button. By selecting the skip button, any remaining portion of the ad is skipped and the next ad is delivered to the user (providing that time remains in the commercial break).

At step 406, the technology determines the amount of time the user viewed the ad. If the user viewed the entire ad, the ad server 104 equates the duration of the ad as the amount of time viewed by the user. If, for example, the first ad was a thirty second ad and the user did not select the skip button, the ad server 104 determines that the amount of time the user viewed the ad is thirty seconds, at step 406. If the user skipped any portion of the ad, the number of seconds that elapsed prior to the skip equates to the time viewed by the user.

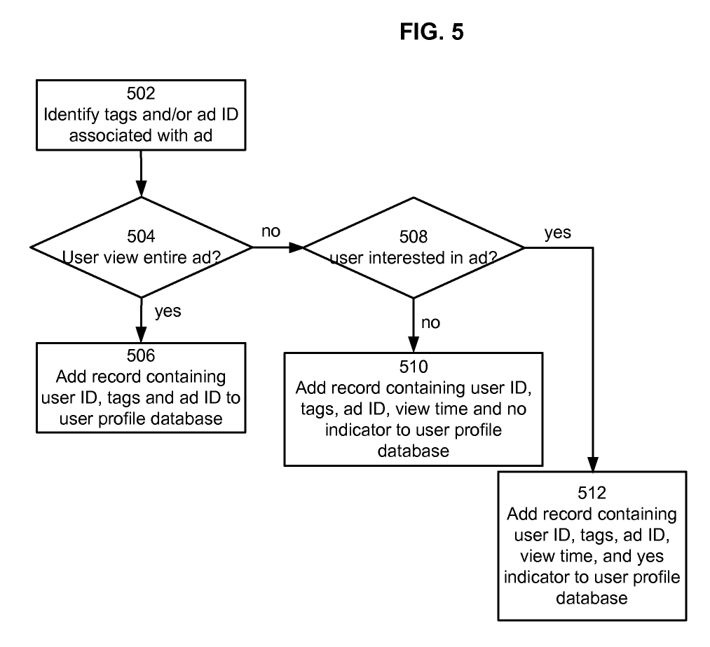

At step 408, the ad server 104 creates a record of the user's viewing behavior and adds the record to the user profile database 106. Additional details of adding the instance of the user's viewing behavior will be provided later herein with reference to FIG. 5. At step 410, the content server 102 determines if there is additional time remaining in the commercial break. If there is no time remaining in the commercial break, the content server 102 begins to deliver the program content to the user, at 412.

If time remains in the commercial break, then at step 414, the amount of time remaining is determined. If, for example, the total commercial break is one minute, a first ad delivered is a thirty-second ad and the user watched it entirely, the technology determines that thirty seconds remains in the commercial break, at step 414. Similarly, if the user skipped fifteen seconds of the first ad, then the technology determines that forty-five seconds of the commercial break remains, at step 414. A content provider attempts to display as many ads during a commercial break as possible in order to maximize the advertising revenue generated during the commercial break. However, because it may not be possible to utilize every second of the commercial break, the ad server 104 determines if the time remaining in the commercial break is less than a predetermined threshold, at step 415. If the time remaining in the commercial break is less than the threshold, at step 415, the user is returned to the program and the content server 102 begins to deliver the content to the user, at step 412. The predetermined threshold may be any number of seconds. If the time remaining in the commercial break exceeds the threshold, at step 415, the ad server 104 proceeds to step 416.

At step 416, the ad server 104 selects a second ad. At step 418, the second ad is delivered to the user. Steps 406-415 are repeated until the ad server 104 identifies that either there is no further time remaining in the commercial break, at step 410, or the time remaining in the commercial break is less than the threshold, at step 415.

Using an example whereby each ad available in the ad database 112 is a thirty-second ad, if a user skips the first ad after watching it for eighteen seconds, a second thirty-second ad delivered to the user, at step 418, would end forty-eight seconds into the one minute commercial break, if the user watches the entire second ad. In this instance, the ad server 104 would determine that there is twelve seconds remaining of the commercial break after the second ad, at step 414. At step 415, the ad server 104 would determine whether twelve seconds is less than the threshold for returning the user to the program, at step 412. If the threshold was less than twelve seconds, the ad server 104 would deliver a third thirty-second ad, at step 418, to the user and the commercial break would last seventy-eight seconds, if the user watches the entire third ad. By doing so, the user is essentially penalized for skipping a portion of the first ad because the user ends up watching seventy-eight seconds of advertising as opposed to the originally scheduled sixty seconds. Returning to step 410, the ad server 104 would determine that there is no time remaining in the commercial break (because seventy-eight seconds exceeds sixty seconds), and the content server 102 would begin providing the program content to the user, at step 412.

FIG. 5 illustrates additional detail of step 408, creating and adding a record of the user's viewing behavior to the user profile database 106. At step 502, the unique ad ID and tags associated with the ad just viewed by the user are identified. In one embodiment, the tags are the standardized tags provided by the system 100. In other embodiments, the tags are the metadata added to the ad by the advertiser 130. In yet other embodiments, the tags comprise a combination of the tags provided by the system 100 and the metadata added to the ad by the advertiser 130.

At step 504, the ad server 104 determines if the user viewed the entire ad or skipped a portion of the ad. The duration of the ad and the amount of time the user viewed the ad (step 406 in FIG. 4) has already been determined. In some embodiments, the ad server 104 determines if the user viewed the entire ad by comparing the amount of time the user viewed the ad with the duration of the ad. If the time the user viewed the ad equals the duration of the ad, the ad server 104 determines that the user viewed the entire ad. If, however, the amount of time the user viewed the ad is less than the duration of the ad, the ad server 104 concludes that the user did not view the entire ad. The ad server 104 may determine whether the user viewed the entire ad by any other means known within the art today.

In some embodiments, if the user viewed the entire ad, the ad server 104 presumes that the user was interested in the ad and proceeds to step 506. At step 506, a record of user viewing behavior, including the tags associated with the ad, the unique ad ID, a user identifier, and a user interest indicator (e.g., 0=user not interested, 1=user interested) is stored in the user profile database 106. In other embodiments, the user interest indicator is a numerical range from, by way of example only, 0-10, based on whether the user selected the advertisement (or the advertisement was selected by the content provider) and the user's viewing time. For example, if a user selected the advertisement and the user watched the advertisement all the way through, the user interest indicator would be a 10. If, on the other hand, the advertisement was selected by the content provider and the user watched the advertisement all the way through, the user interest indicator may be an 8. If the user watched the advertisement 75% of the way through (and the advertisement was selected by the content provider), the user interest indicator may be a 6, and so on. A user interest indicator with such a graded scale allows the technology described herein to differentiate further between subject matter that is of interest to a user.

Many different user identifiers may be used here. For example, if the content provider required the user to sign-in to the website to view the content, the content provider may know a username, the user's email address, or any other information the user provided during the registration process. Any of the information provided by the user may comprise a user identifier. In other embodiments, the user identifier may include an Internet Protocol (IP) address, a MAC address, device ID (e.g., set-top box serial number, MSISDN, etc.), and the like associated with the device 132 receiving the content.

If the ad server 104 determines that the user skipped a portion of the ad (step 504), the ad server 104 determines if the user was interested in the ad, at step 508. If the ad server 104 determines that the user was not interested in the ad, a record is created including the user ID, tags associated with the ad, ad ID, view time, and a “no” indicator flag, and the record is added to the user profile database 106, at step 510. If the ad server 104 determines that the user was interested in the ad at step 508, a record including the user ID, tags associated with the ad, ad ID, view time, and a “yes” indicator flag, and the record is added to the user profile database 106, at step 512. The records added to the user profile database 106 may be stored in the user profile database 106 according to any database model know in the art today. Each set of data contained in a record is referred to as an instance of user viewing behavior. By storing records of user viewing behavior, the user profile database 106 becomes a searchable database that can be analyzed by the user behavior engine 108.

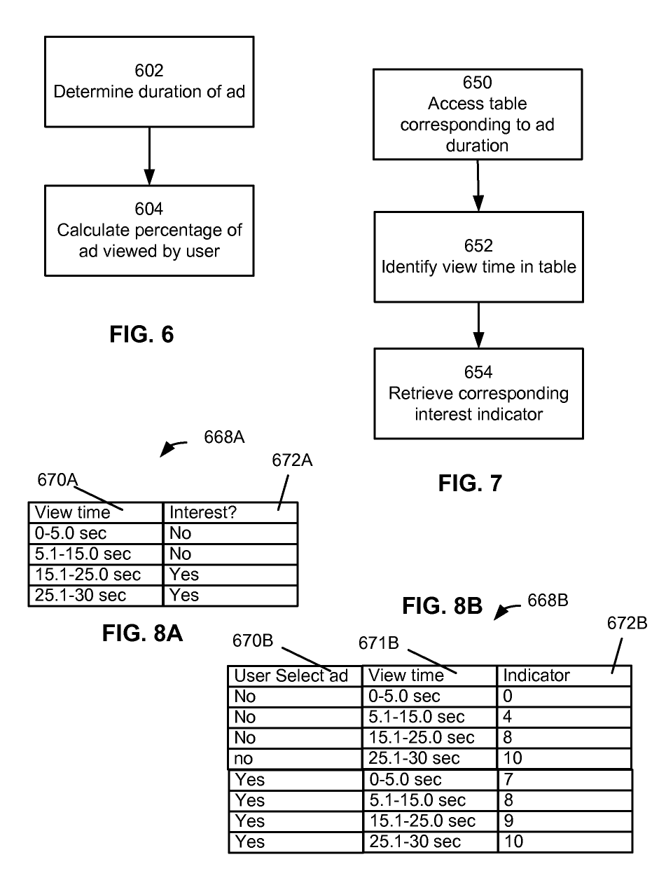

FIG. 6 illustrates a flow chart of one embodiment of determining if the viewer was interested in the ad (step 508 in FIG. 5). To determine whether a user was interested in an ad based on the amount of time the user viewed the ad requires knowing the duration of the ad. At step 602, the technology determines the duration of the ad. For the purpose of describing the technology disclosed herein only, the technology determines that the duration of the ad just presented to the user was thirty seconds, at step 602. The amount of time that the user watched the ad has been determined at step 406 (FIG. 4). Suppose the user viewed the thirty second ad for only eighteen seconds. At step 604, the technology calculates the percentage of the ad that was watched by the user. In this instance, the technology calculates that the user viewed sixty percent of the ad (18 seconds/30 seconds). In some embodiments, the technology may equate a user watching more than fifty-percent of an ad as the user was interested in the ad. Any percentage may be used as a threshold for determining if a user was interested in the ad.

FIG. 7 illustrates another embodiment for determining whether the viewer was interested in the ad (step 508). As described above, the duration of the ad and the amount of time the user watched the as has been determined. The amount of time a user watched an ad, by itself, is not enough information to determine whether the user was interested in the ad. For example, a user watching eighteen seconds of a twenty second ad may indicate that the user was interested in the ad because the user watched most of the ad. However, a user watching eighteen seconds of a forty-five second ad may not indicate that the user was interested in the ad because the user did not watch much of the ad.

At step 650, the ad server 104 accesses a view table (see FIGS. 8A-8B) corresponding to the duration of the ad just viewed by the user. Using the example provided above, the ad server 104 accesses a view table corresponding to a thirty-second ad. FIG. 8A illustrates one embodiment of a view table 668A corresponding to a thirty-second ad. The view table 668A includes two columns: a view time column 670A and an interest column 672A. FIG. 8A illustrates that the view table 668A includes four ranges of view times: 0-5.0 seconds, 5.1-15.0 seconds, 15.1-25.0 seconds and 25.1-30 seconds. These view time are exemplary, and are not intended to limit the scope of the technology described herein. Each of the ranges of view times corresponds to a user interest indicator (e.g., “yes”=1, “no”=0). FIG. 8B illustrates another example of a view table 668B. In FIG. 8B, the user interest indicator (column 672B) is based on both the amount of time a user views an advertisement (column 672B) and whether the user selected the advertisement (column 671B).

The view table 668A indicates that a user is not interested in an ad if the user viewed the ad for 15 seconds or less, and a user is interested in an ad if the user viewed the ad for more than 15.1 seconds. Using the example above whereby the user viewed the ad for eighteen seconds, the ad server 104 identifies that the user's view time correlates with the row containing the time range 15.1-25 seconds, at step 652. At step 654, the ad server 104 retrieves a “yes” indicator from the table 668. A “yes” indicator indicates that the user is interested in the ad based on the amount of time the user watched the ad, at step 508 in FIG. 5. Returning to FIG. 5, a record is created containing the user's ID, tags associated with the ad, ad ID, amount of time the user viewed the ad, and a “yes” flag, and the record is added to the user profile database 106, at step 512. The view time column 670 may also be represented in terms of percentages (e.g., 0-100%) so that the calculated percentage (step 604 in FIG. 6) can be used to determine an interest indicator 672. Using the view table 668B, the user interest indicator is a range between 0-10.

A tension exists between the content provider and advertiser with regard to monetizing the ads. Advertisers do not want to pay the content provider for partially viewed ads. On the other hand, the content provider, at some point, should receive payment for providing the ad to the user even though the user does not view the entire ad.

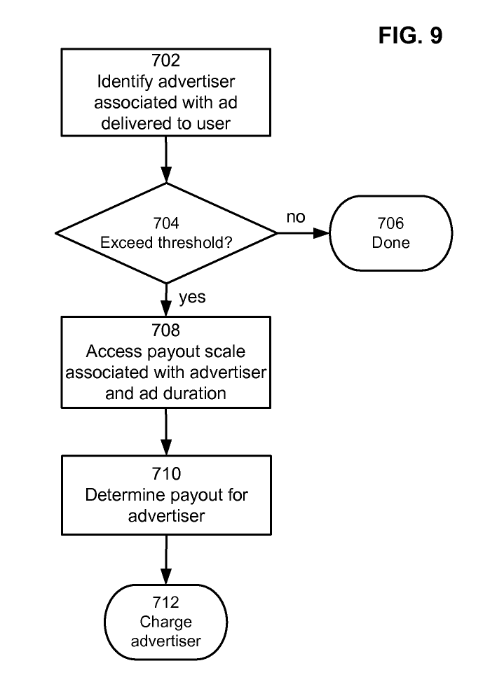

FIG. 9 illustrates exemplary steps performed by the system 100 in order to generate revenue for the content provider based on partial delivery of ads. As discussed above, a user is allowed to skip a portion of an advertisement. A content provider would like to be able to charge advertisers for partial delivery of an ad. In some embodiments, the steps shown in FIG. 9 occur every time an ad is viewed (or partially viewed) by a user. In other embodiments, steps 702-710 are performed every time an ad is viewed by a user, but step 712 is performed only periodically. At step 702, the ad server 104, upon delivering an ad to a user, identifies the advertiser associated with the ad. In some embodiments, the advertiser is identified based on the unique ad ID associated with the ad. In other embodiments, the advertiser is identified by the metadata attached to the ad when received from the advertiser.

At step 704, the ad server 104 determines if the amount of time the user viewed the ad exceeds a minimum view time. The amount of time the user watched the ad was determined at step 406 (FIG. 4). A minimum view time is a threshold whereby the advertiser does not have to pay the content provider for delivering the ad to the user if the time the user views the ad does not exceed the threshold. In some embodiments, the threshold is a minimum amount of time (e.g. seconds), and the advertiser does not have to pay the content provider for delivering the ad to the user, at step 706, if the user does not view the ad for more than the minimum amount of time. In other embodiments, the threshold is a percentage of the ad that the user watched, and is used to determine whether the advertiser is responsible for paying the content provider for delivering the ad to the user.

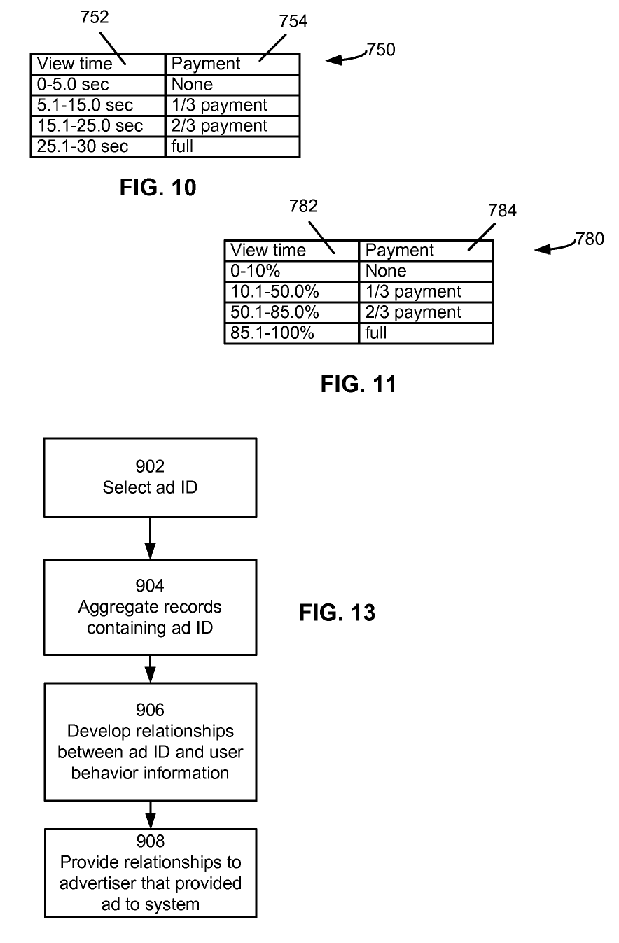

If the amount of time the user views an ad exceeds the threshold, the technology proceeds to step 708. At step 708, the technology accesses a payout scale associated with the advertiser that provided the ad. Exemplary payout scales are shown in FIGS. 10 and 11, and will be discussed in more detail later. At step 710, the technology determines the advertiser payout based on the amount of time the user viewed the ad.

At step 712, the content provider charges the advertiser for delivering the ad to the user. In some embodiments, the content provider charges the advertiser, at step 712, every time the ad is delivered to a user. In other embodiments, the number of times the ad is delivered to a user is accounted for, and each month (or any other time period) the content provider charges the advertiser accordingly. It is also within the scope of the technology described herein to issue a bill to an advertiser upon reaching a threshold limit (e.g., $1,000). Any threshold amount may be used. Any method known in the art for monetizing the delivery of ads is within the scope of the technology described herein.

FIGS. 10-11 illustrate exemplary payout scales used to determine advertiser payout, at step 710 (in FIG. 9). The payout scale 750 shown in FIG. 10 is based on the number of seconds the user viewed the ad. The payout scale 750 includes a view time column 752 and a payment column 754. The view time column 752 includes the following ranges of view times: 0-5 seconds, 5.1-15.0 seconds, 15.1-25.0 seconds and 25.1-30 seconds. The corresponding payout column 754 illustrates that an advertiser will not make any payment if the user views the ad for less than five seconds; the advertiser will pay ⅓ of the negotiated payment if the user views the ad between 5.1-15.0 seconds; the advertiser will pay ⅔ of the payment if the user views the ad between 15.1-25.0 seconds; and the advertiser will make a full payment if the user views the ad for at least 25.1 seconds. By way of example only, suppose the advertiser agreed to pay the content provider $0.66 each time their ad is viewed by a user. The corresponding payout column 754 illustrates that an advertiser would pay the content provider $0 if a user views the ad for less than five seconds; $0.22 if a user views the ad between 5.1-15.0 seconds; $0.44 if a user views the ad between 15.1-25.0 seconds; and $0.66 if a user views the ad for at least 25.1 seconds. These ranges of time are exemplary only, and are not intended to the limit the scope of the technology described herein.

FIG. 11 illustrates a payout scale 780 based on the percentage of the ad viewed by a user. The payout scale 780 includes a view time column 782 and a payment column 784. The view time column 782 includes the following percentages of view times: 0-10%, 10.1-50.0%, 50.1-85.0% and 85.1-100%. Again, suppose the advertiser agreed to pay the content provider $0.66 for each time the ad is viewed by a user. The corresponding payout column 784 illustrates that the advertiser pays the content provider $0 if the user views less than 10% of the ad; $0.22 if the user views between 10.1-50% of the ad; $0.44 if the user views between 50.1-85% of the ad; and $0.66 if the user views between 85.1-100% of the ad. These ranges of percentages are exemplary only, and are not intended to the limit the scope of the technology described herein.

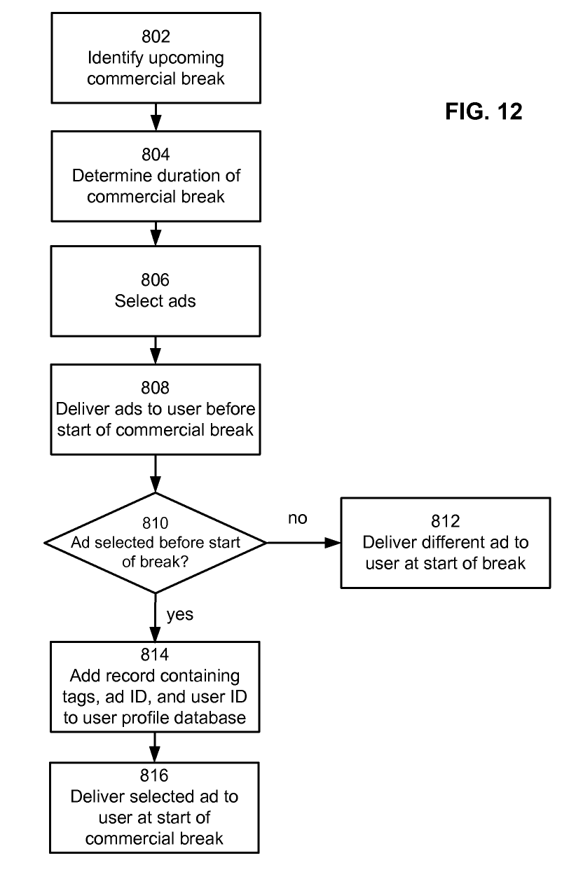

FIG. 12 illustrates exemplary steps of another embodiment of presenting ads to a user during a commercial break. Using the example provided above, at step 802, the content server 102 identifies an upcoming commercial break in the program. At step 804, the content server 102 determines the duration of the commercial break is one minute long. The duration of a commercial break may vary.

At step 806, the ad server 104 selects a certain number of ads from the ad database 112. Any number of ads may be selected at step 806. For the purpose of describing the technology only, the ad server 104 selects a first ad, a second ad and a third ad. In some embodiments, the ads are randomly selected from the ad database 112 at step 806. In other embodiments, the ads selected in step 806 are based, in part, on the user's viewing behavior stored in the user profile database 106.

At step 808, the ad server 104 delivers the three ads to the user before the beginning of the commercial break. In one embodiment, the three ads selected in step 806 are presented to the user via a pop-up window. For example, a pop-up window may be presented displaying a static frame of each ad along with a message indicating that a commercial break is about to begin, and a message requesting the user to select one of the three ads. In other embodiments, a static image from each of the three ads is displayed in an area of the GUI that the user is viewing the program that does not obscure or block any portion of the program being broadcast.

At step 810, the ad server 104 determines if the user selected one of the three ads. In one embodiment, if the user does not select one of the three ads, the ad server automatically delivers one of the three ads (selected at step 806) at the beginning of the commercial break, at step 812. Alternatively, the ad server may deliver a different ad from the ad database 112 at the beginning of the commercial break (e.g., not one of the three ads). If the user does not select one of the three ads, the ad server 104 does not create a record and add it to the user profile database 106. In other embodiments, the ad server 104 creates a record including the tags associated with the unselected ad, ad ID and used identifier, and adds the record to the user profile database 106.

If the user selects one of the three ads selected in step 806, the ad server 104 creates a record including the tags associated with the ad, ad ID, and user identifier, and adds the record to the user profile database 106, at step 814. At step 816, the ad server 104 delivers the selected ad to the user.

The methods disclosed above create a searchable database of records of user viewing behavior that can provide a deep level of granularity to advertisers interested in improving the targeting of their advertisements. FIG. 13 illustrates exemplary steps of providing user viewing behavior to an advertiser that would like feedback regarding how a specific ad is being received by users. A content provider having control over the user profile database 106 may charge advertisers for providing feedback on whether users are viewing a certain ad, how the ad is performing in comparison to related ads, and so on.

At step 902, the user behavior engine 108 selects the ad ID associated with the specific ad the advertiser requested feedback about. At step 904, the user behavior engine 108 aggregates the records of user viewing behavior stored in the user profile database 106 that contain the ad ID selected in step 902. As discussed above, each record is stored in the user profile database 106, and includes, among other things, an ad ID, tags associated with the ad, and user identifier. Some records will also include the amount of time the user viewed the ad.

At step 906, the user behavior engine 108 develops relationships between the information contained in the records of user viewing behavior aggregated in step 904. Many different types of relationships may be developed. In one embodiment, the user behavior engine 108 analyzes the information contained in the records to determine what percent of users watched the ad all the way through. In other embodiments, the user behavior engine 108 analyzes the information to determine the percentage of users that skipped the ad. Other relationships developed by the user behavior engine 108 may include the percentage of users that watched at least five seconds of the ad, at least ten seconds of the ad, and so on. These relationships developed by the user behavior engine 108 are exemplary only, and are not intended to limit the scope of the technology. At step 908, the user behavior engine 108 provides the relationship(s) to the advertiser that presented the ad.

The subject matter of the present technology is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

While the present technology has been described in connection with the embodiments of the various figures, it is to be understood that other similar embodiments may be used or modifications and additions may be made to the described embodiment for performing the same function of the present technology without deviating therefrom. Therefore, the present technology should not be limited to any single embodiment, but rather should be construed in breadth and scope in accordance with the appended claims.

I claim:

1. A method for measuring resonance of an ad with a user, comprising:
delivering an ad to a user during a commercial break of a program being delivered by a content provider to the user, the ad being associated with a unique identifier;
receiving input from the user during presentation of the ad indicating that the user would like to stop viewing at least a portion of the ad before the ad has ended;
determining the user's interest in the ad based on the amount of time that the user viewed the ad; and
creating a record of user viewing behavior, the record including the unique identifier and a user identifier;
storing the record in a user profile database.

2. The method as recited in claim 1, wherein the step of creating a record of user viewing behavior comprises the step of:
creating the record of user viewing behavior, the record including the unique identifier and a tag associated with the ad with at least one of the following user identifiers: username, Internet Protocol address, email address, or Media Access Control address.

3. The method as recited in claim 2, wherein the step of creating a record of user viewing behavior further includes the step of:
creating a record of user viewing behavior that further includes the amount of time that the user viewed the ad.

4. The method as recited in claim 1, wherein the step of determining the user's interest in the ad comprises the steps of:
determining a duration of the ad;
determining the amount of time the user viewed the ad;
accessing a view time table that correlates with the duration of the ad; and
determining a user interest indicator in the view time table that corresponds to the amount of time that the user viewed the ad.

5. The method as recited in claim 1, wherein the step of determining the user's interest in the ad comprises the steps of:
determining a duration of the ad;
determining the amount of time the user viewed the ad;
calculating a percentage of the ad that was viewed by the user based on the amount of time the user viewed the ad and the duration of the ad; and
determining a user interest indicator in a view time table that corresponds to the calculated percentage.

6. The method as recited in claim 1, further including the steps of:
determining that an amount of time remains during the commercial break after presentation of the first ad;
delivering a second ad to the user.

7. The method as recited in claim 6, wherein the step of delivering a second ad to the user comprises the steps of:
selecting a second ad to deliver to the user;
determining whether the second ad has a duration that is less than the amount of time remaining during the commercial break;
delivering the second ad to the user if the second ad has a duration that is less than the amount of time remaining during the commercial break; and
returning the user to the program if the second ad has a duration that is more than the amount of time remaining during the commercial break.

8. The method as recited in claim 1, wherein the step of providing an ad to a user during a commercial break of a program being streamed by a content provider to the user comprises the steps of:
generating a unique identifier;
selecting a subject matter tag based on metadata associated with the ad; and
associating the unique identifier and subject matter tag with the ad before providing the ad to the user during the commercial break.

9. The method as recited in claim 1, further comprising the step of:
billing the advertiser for delivering the ad to a user based on the amount of time the user viewed the ad.

10. A method for measuring resonance of an ad with a user, comprising:
identifying an upcoming commercial break in a program being delivered by a content provider to a user;
selecting at least two ads from an advertising database, each ad associated with at least one subject matter tag describing an attribute of the ad;
delivering the at least two ads to the user viewing the program prior to the start of the commercial break, wherein the at least two ads are displayed for selection by the user;
receiving input from the user indicating that the user selected one of the at least two ads;
storing the user viewing behavior associated with the selected ad in a user profile database; and
delivering the selected ad to the user upon the start of the commercial break.

11. The method as recited in claim 10, wherein the step of storing the user viewing behavior comprises the steps of:
storing the at least one tag describing an attribute of the selected ad and a user identifier as a record in the user profile database.

12. The method as recited in claim 10, further comprising the steps of:
receiving input from the user during presentation of the selected ad indicating that the user would like to stop viewing the selected ad before the selected ad has ended;
determining the user's interest in the selected ad based on the amount of time that the user viewed the selected ad;
creating a record of user viewing behavior; and
storing the record in the user profile database.

13. The method as recited in claim 12, wherein the step of creating a record of user viewing behavior comprises the step of:
creating a record of user viewing behavior, the record including at least one subject matter tag associated with the selected ad, a user identifier, and a user interest indicator.

14. The method as recited in claim 10, further comprising the steps of:
selecting a unique identifier associated with an ad;
aggregating the user viewing behavior stored in the user profile database based on the unique identifier associated with the ad; and
developing relationships of user viewing behavior associated with the unique identifier.

15. The method as recited in claim 14, further comprising the step of:
providing the developed relationships of user viewing behavior to an advertiser associated with the ad.

16. The method as recited in claim 15, further comprising the step of:
billing the advertiser based on the amount of time the user viewed the selected ad.

17. The method as recited in claim 10, further comprising the steps of:
aggregating the user viewing behavior by any of the following: a user ID, ad ID, subject matter tags associated with the ad, or user interest indicator.

18. A system for measuring resonance of an ad with a user, comprising:
a content server configured to deliver content to a user, the content including a commercial break;
an ad server configured to deliver at least one ad to a user during the commercial break, receive feedback from the user during the presentation of each ad to skip viewing an ad before the ad has ended, determine the user's interest in the ad based on the amount of time that the user viewed the ad; and
a user profile database configured to store each instance of the user viewing behavior.

19. The system as recited in claim 18, further comprising:
a user behavior engine configured to develop relationships between the instances of user viewing behavior stored in the user profile database.

20. The system as recited in claim 18, wherein the ad sever is further configured to bill the advertiser associated with the ad delivered by the content server based on the amount of time that the user viewed the ad.
